(19) United States
(12) Patent Application Publication
(10) Pub. No.: US 2003/0015241 A1
(43) Pub. Date: Jan. 23, 2003

(54) Filtered tire inflation valve

(76) Inventor: Robert D. Fogal SR., Chambersburg, PA (US)

Correspondence Address: HAHN LOESER & PARKS, LLP, TWIN OAKS ESTATE, 1225 W. MARKET STREET, AKRON, OH, 44313, US

(21) Appl. No.: 10/119,602

(22) Filed: Apr. 10, 2002

Related U.S. Application Data
(60) Provisional application No. 60/307,051, filed on Jul. 20, 2001.

(51) Int. Cl. F16K 15/20

(52) U.S. Cl. 137/550

(57) ABSTRACT

A pneumatic tire inflation valve having a filter positioned at an outlet end thereof capable of filtering the air released from within the tire through the valve core to prevent foreign matter contained within the tire from entering the valve core seat assembly and the atmosphere. The present invention also prevents foreign matter, which may be contained within a tire from being forced into the valve core over time through use of the tire and due to routine checking of tire air pressure.

### FIELD OF THE INVENTION

The present invention relates generally to an inflation valve for a pneumatic tire and more specifically to an inflation valve having a filter positioned at an outlet end thereof capable of filtering the air released from within the tire through the valve core to prevent foreign matter contained within the tire from entering the valve core seat assembly and the atmosphere. The present invention also prevents foreign matter which may be contained within a tire from being forced into the valve core over time through use of the tire and due to routine checking of tire air pressure.

### BACKGROUND OF THE INVENTION

It has become standard practice to dynamically balance tire/wheel assemblies using lead balance weights. However, even dynamically balanced tires can be susceptible to vibration when in use on a vehicle due to non-uniformities in the tire such as radial runout or out-of roundness, radial force variations, and lateral force variations or conicity, or due to other factors related to the vehicle or road. In part due to the inadequacies of dynamic balancing and in part due to environmental concerns, it is becoming increasingly popular to purposely introduce a flowable material into the pressure chamber of a tire/wheel assembly to improve the performance and ride characteristics of the vehicle. The flowable materials react to forces at the tire/road footprint to reduce vibration and noise as t aught and described in applicant's prior U.S. Pat. No. 5,073,217, which is herein incorporated by reference. The particulate composition is sold by International Marketing, Inc. under the trademark EQUAL®.

Flowable materials must be made of small particles or powders to work effectively. These various powders and substances may cause loss of air through the tire valve core, especially upon the checking of tire air pressure. The small size of the particles allows the particles to enter the valve core assembly and these particles may adversely affect the valve core components or their operation. Furthermore, it is desirable to prevent these installed substances from escaping the tire. By preventing the escape of the pulverulent powder, the powder does not enter the atmosphere and does not need to be replenished when the tire is re-inflated.

In the past, flowable materials such as EQUALS® were typically directly injected into a partially or fully inflated tire through the tire valve. This is accomplished by introducing the powder or particulate matter directly into the valve under pressure such as in combination with compressed air to force the powder into the interior of the tire. This made it possible for particles of the flowable material to become stuck in the tire valve and disrupt operation of the valve core. Also, it is not uncommon for a tire to contain other particulate matter such as dust, dirt, and as a consequence of use whereby particles of rubber become dislodged from the interior bead of the tire and freely move about the interior of the tire when the tire is in use. Over time, a large number of such particles may be found in any tire. It is not uncommon for these particles to enter into the tire valve core and prevent the valve from filly closing resulting in an air leak. This is especially likely to occur when air is released from the tire as the flow of air exiting the valve naturally draws the particles into the valve core.

Filtered tire inflation valve assemblies have been provided such as that shown in commonly owned U.S. Pat. No. 6,035,885, herein incorporated by reference. However, filtered tire inflation valve assemblies are generally complex, require special assembly, and/or are relatively expensive. Therefore there remains a need in the art for a simple, inexpensive, and effective filtered tire inflation valve that can be easily made from existing tire inflation valves.

### SUMMARY OF THE INVENTION

The present invention provides a novel filtered inflation valve having a filter positioned at an outlet end thereof. The filter prevents clogging of the inflation valve by foreign particles and flowable material particles housed in the pressure chamber of the tire/wheel assembly. The filtered inflation valve is simple, cost-effective, and easily made from existing inflation valves.

These and other advantages of the present invention are provided by a pneumatic tire inflation valve assembly comprising a pneumatic inflation valve body having a first end, a second end, and a central bore extending from the first end to the second end of the valve body, a valve core positioned in the central bore near the first end of valve body, a filter attached to the second end of the valve body, wherein the filter is positioned covering the central bore at the second end of the valve body.

These and other advantages are also provided by a method of converting a pneumatic tire inflation valve body to a filtered pneumatic tire inflation valve body comprising the following steps. First, providing a pneumatic inflation valve body having a first end, a second end, and a central bore extending from the first end to the second end of the valve body. Secondly, machining a counterbore into the second end of the valve body. Thirdly, placing an adhesive on the counterbore. Then positioning the filter within the counterbore such that the filter is secured to the valve body by the adhesive and such that the filter covers the central bore.

### BRIEF DESCRIPTION OF THE DRAWINGS

FIG. 1 is an elevational view showing the valve of the present invention as it may be installed in a wheel rim (the rim shown in ghost lines);

FIG. 2 is an enlarged elevational longitudinal cross-section of the present invention;

FIG. 3 is a plan view as it may be taken at line 3-3 of FIG. 2;

FIG. 4 is an enlarged elevational longitudinal cross-sectional detail view of another embodiment of the present invention.

### DETAILED DESCRIPTION OF THE DRAWINGS

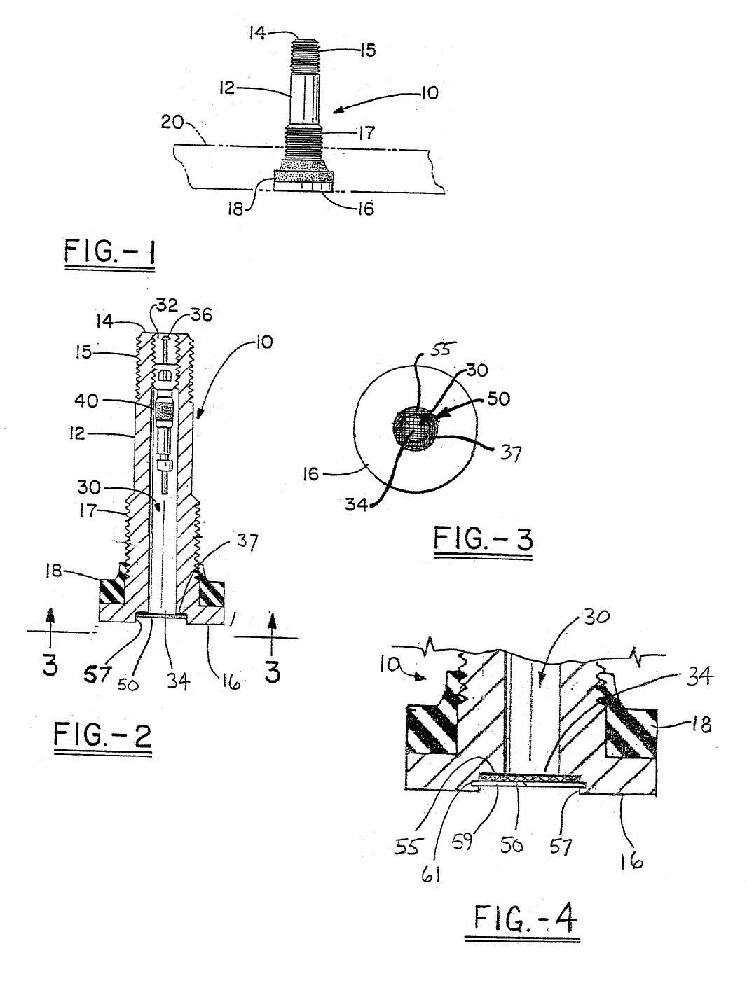

Reference will now be made in detail to the preferred embodiment of the present invention which is illustrated in the accompanying drawings. Referring to FIG. 1, the invention is shown generally at 10 and comprises an elongated valve body 12 having a first end 14 and a second end 16. First end 14 may contain external threads 15 to allow for the attachment of a protective cap or to allow for the attachment of a mating pneumatic fitting. Additional external threads 17 may be provided along the valve body 12 to allow for attachment of valve body 12 to wheel rim 20 using a nut or a nut and a washer (not shown). Second end 16 preferably includes an annular rubber seal 18 to provide for an airtight seal between second end 16 of valve body 12 and wheel rim 20. Many shapes and sizes and varieties of valve bodies are known in the art and the present invention is not meant to be limited to any particular valve body or any particular method of attachment with wheel rim 20. For example, second end 16 may be covered by a rubber exterior and snapped into attachment with wheel rim 20 through an aperture. In particular, those skilled in the art will recognize that the disclosure and figures may apply equally to a valve sized and configured for use with automobile and light truck tires, as well a valve sized and configured for use with tires and wheels of heavy duty over-the-road and off-road trucks, aircraft, etc.

As seen in FIG. 2, a central passageway or bore 30 extends from first end 14 to second end 16 of valve body 12. Passageway 30 defines an inlet port 32 at first end 14 of valve body, and defines an outlet port 34 at second end 16 of valve body 12. Valve means which is preferably a pneumatic valve or valve core 40 is disposed in passageway 30. Valve core 40 is threadably secured at or near first end 14 of passageway 30 and descends from first end 14 into passageway. Valve pin 36 is biased by means of a spring to extend into inlet port 32 to be capable of being depressed by a mating pneumatic fitting or other implement as is known in the art to open valve core 40 to allow air to pass through passageway 30. It should again be noted that many such valve cores are known in the art, one such valve core being made by Schrader Automotive, Inc., Charlotte, N.C., and being commonly known in the industry as a Schrader Valve. The invention however is not meant to be limited to any particular type of valve core.

As shown in FIGS. 2 and 3, a filter element 50, shown as a screen, is provided in fluid communication at the end of passageway 30 and is preferably mounted in a counterbore or filter screen seat 55 formed on the bottom surface of second end 16. Filter element 50 is not limited to any particular type, size, or shape. Filter element 50 is larger in cross-sectional diameter than passageway 30. Filter element 50, which in the embodiment shown is circular in shape, is attached to the screen seat on the bottom surface of second end 16 by an adhesive 37. Other attachment methods are also contemplated such as a retaining ring 59 mating in a retaining ring groove 61 as shown in FIG. 4. Other suitable attachment methods are contemplated and the present invention is not limited to the examples shown herein.

Filter member or screen 50 should allow for the passage of air but be substantially impervious to small particles or powders such as pulverulent matter. Users of particulate flowable material injectors will not be able to use the valve stem 10 as the filter screen 50 will not allow such particulate matter to be introduced into the valve core seat because the filter screen 50 blocks the particulate matter. Users of particulate flowable material will need to use an alternate insertion method such as the drop-in bag which is disclosed in commonly owned U.S. Pat. No. 6,249,97 1, herein incorporated by reference.

In operation, the invention 10 is installed in a tire wheel rim 20 using the same methods as would be used to install a conventional tire valve stem. A tire is also mounted on rim 20. Filter screen 50 prevents particulate flowable materials from entering into valve 10. When purposefully deflating a tire/wheel assembly by depressing the valve core 40, it may be necessary to apply a short blast of compressed air through valve 10 to dislodge particle that may be trapped on filter screen 50. This will permit the free flow of air past filter screen 50.

In tires in which particulate compositions such as EQUAL® have not been installed, this invention also prevents any other particulate matter, such as dust, dirt, and small pieces of rubber which may be contained within the tire, from being forced into filter 10 and interfering with the flow of air or the operation of the valve core seat.

Another advantage of the present invention is the location of the filter 50 at the outlet 34 of the inflation valve 10. This location provides an improvement over prior art filtered inflation where the filter element is adjacent the valve core 40 or in or near passageway 30. The foreign particles in these prior art inflation valves are able to enter portions of the inflation valve where they can become stuck and prevent airflow or prevent proper operation of valve core 40.

The valve 10 of the present invention is easily made from existing inflation valves. In the quickest conversion a filter screen 50 is simply adhered to the bottom surface of second end 16 with adhesive 53 such that the filter screen 50 covers the outlet port 34 at second end 16 of valve body 12. In order to protect the screen 50 during handling, it is preferred that a counterbore is formed or machined into the bottom surface of second end 16 to form a filter screen seat 55 and is not dependent upon the material that the second end 16 is made of or if the second end 16 is covered by another material such as rubber. The adhesive 53 would be placed on screen seat 55 and hold the filter screen 50 in position over outlet port 34. As previously mentioned, it is contemplated that many methods of attaching filter screen 50 to the second-end 16 of valve body 12 may be available to and hold the filter screen 50 in position over outlet port 34. One such contemplated method is to insert filter screen 50 into counterbore 55 and position a retaining ring 59 into a groove 61 in the walls 57 of counterbore 55 to retain filter screen 50 in position over outlet port 34.

While the foregoing description has set forth the preferred embodiment of the invention in particular detail, it must be understood that numerous modifications, substitutions and changes can be undertaken without departing from the true spirit and scope of the present invention. Although the present invention has been described above in detail, the same is by way of illustration and example only and is not to be taken as a limitation on the present invention. Accordingly, the scope and content of the present invention are to be defined only by the terms of the appended claims.

What is claimed is:

1. A pneumatic tire inflation valve body comprising:
A pneumatic inflation valve body having a first end, a second end, and a central bore extending from the first end to the second end of the valve body;
a filter attached to the second end of valve body;
wherein the filter is positioned covering central bore at the second end of valve body.

2. The pneumatic tire inflation valve body of claim 1, wherein the filter is attached to the second end of the valve body by an adhesive.

3. The pneumatic tire inflation valve body of claim 1, wherein the second end of the pneumatic inflation valve body comprises a counterbore centrally located about the central bore, wherein the filter is positioned within the counterbore.

4. The pneumatic tire inflation valve body of claim 3, wherein the filter is attached to the counterbore of the second end of the pneumatic inflation valve body by an adhesive.

5. The pneumatic tire inflation valve body of claim 3, wherein the filter is attached to the counterbore of the second end of the valve body by a retaining ring.

6. The pneumatic tire inflation valve body of claim 1, wherein the filter is a screen.

7. A pneumatic tire inflation valve assembly comprising:
a pneumatic inflation valve body having a first end, a second end, and a central bore extending from the first end to the second end of the valve body;
a valve core positioned in the central bore near the first end of the valve body;
a filter attached to the second end of the valve body;
wherein the filter is positioned covering central bore at the second end of the valve body.

8. The pneumatic tire inflation valve assembly of claim 1, wherein the filter is attached to the second end of the valve body by an adhesive.

9. The pneumatic tire inflation valve assembly of claim 1, wherein the second end of the pneumatic inflation valve body comprises a counterbore centrally located about the central bore, wherein the filter is positioned within the counterbore.

10. The pneumatic tire inflation valve assembly of claim 3, wherein the filter is attached to the counterbore of the second end of the pneumatic inflation valve body by an adhesive.

11. The pneumatic tire inflation valve assembly of claim 3, wherein the filter is attached to the counterbore of the second end by a retaining ring.

12. The pneumatic tire inflation valve assembly of claim 1, wherein the filter is a screen.

13. A method of converting a pneumatic tire inflation valve body to a filtered pneumatic tire inflation valve body comprising the following steps:
a) providing a pneumatic inflation valve body having a first end, a second end, and a central bore extending from the first end to the second end of the valve body;
b) attaching a filter to the second end of the valve body such that the filter covers the central bore.

14. The method of claim 13 wherein the filter attachment step comprises the following steps:
a) machining a counterbore into the second end of the valve body;
c) placing an adhesive on the counterbore;
d) positioning the filter within the counterbore such that the filter is secured to the valve body by the adhesive and such that the filter covers the central bore.

15. The method of claim 13 wherein the filter attachment step comprises the following steps:
a) machining a counterbore into the second end of the valve body;
c) machining a retaining ring groove in the counterbore;
d) positioning the filter within the counterbore such that the filter is positioned over the central bore;
e) securing the filter within the counterbore with a retaining ring.

16. The method of claim 13 wherein the filter is attached to the valve body by an adhesive.

17. The method of claim 13 wherein the filter is attached to the valve body by welding.

18. The method of claim 13, wherein the filter is a screen.

19. A method of converting a pneumatic tire inflation valve body to a filtered pneumatic tire inflation valve body comprising the following steps:
a) providing a pneumatic inflation valve body having a first end, a second end, and a central bore extending from the first end to the second end of the valve body;
b) machining a counterbore into the second end of the valve body;
c) machining a retaining ring groove in the counterbore;
d) positioning the filter within the counterbore; and
e) positioning a retaining ring over the filter within the counterbore such that the filter is secured to the valve body by the retaining ring and such that the filter covers the central bore.

20. The method of claim 15, wherein the filter is a screen.
